(19) United States
(12) Patent Application Publication
(10) Pub. No.: US 2023/0340248 A1
(43) Pub. Date: Oct. 26, 2023

(54) RESIN TUBE AND METHOD FOR MANUFACTURING THE SAME

(71) Applicant: Proterial, Ltd., Tokyo (JP)

(72) Inventors: Hiroo KUSANO, Tokyo (JP); Detian HUANG, Tokyo (JP)

(73) Assignee: Proterial, Ltd., Tokyo (JP)

(21) Appl. No.: 18/300,153

(22) Filed: Apr. 13, 2023

(30) Foreign Application Priority Data
Apr. 20, 2022 (JP) 2022-069660

(51) Int. Cl. C08L 27/18; C08F 2/22; C08F 14/18

(52) U.S. Cl. CPC C08L 27/18; C08F 2/22; C08F 14/18; C08L 2205/03; C08L 2205/025; C08F 2500/02

(57) ABSTRACT

A resin tube is a tube that is composed of a first fluoropolymer and a second fluoropolymer. The first fluoropolymer is made of a melt-type fluoropolymer that melts at a temperature higher than a melting point, and the second fluoropolymer is made of polytetrafluoroethylene or a cross-linked fluoropolymer. An inner circumferential surface of the tube has irregularities with arithmetic average roughness Ra of 1 μm or more.

### CROSS-REFERENCE TO RELATED APPLICATIONS

The present application is based on Japanese patent application No. 2022-069660 filed on Apr. 20, 2022, the entire contents of which are incorporated herein by reference.

### TECHNICAL FIELD

The present invention relates to a resin tube made using a fluoropolymer (fluoro resin) composition and a method for manufacturing the same.

### BACKGROUND OF THE INVENTION

Electric wires or cables routed in industrial robots used in production lines involving welding and parts assembly, etc., of automobiles are repeatedly bent and twisted. Conventionally, to protect plural electric wires or cables that are routed in a moving part of an industrial robot, a flexible resin tube is provided to cover the plural electric wires or cables (see, e.g., Patent Literature 1).

### Citation List Patent Literature 1: JP2021-74850A

### SUMMARY OF THE INVENTION

Resin tubes as described above are required to be designed so that abrasion is less likely to occur between the inner circumferential surface of the resin tube and the electric wires or cables to suppress wire breakage (i.e., disconnection) due to such abrasion. For this reason, sliding properties (i.e., slipperiness) of the inner circumferential surfaces of the resin tubes are required to be high. In addition, the resin tubes are required to have high abrasion resistance to suppress damage on the resin tubes per se due to contact of their inner circumferential surfaces with the electric wires or cables.

Therefore, it is an object of the invention to provide a resin tube with improved sliding properties and abrasion resistance and a method for manufacturing the resin tube.

To solve the problem described above, the invention provides a resin tube, comprising:
a tube that comprises a first fluoropolymer and a second fluoropolymer, the first fluoropolymer comprising a melt-type fluoropolymer that melts at a temperature higher
than a melting point, and the second fluoropolymer comprising polytetrafluoroethylene or a cross-linked fluoropolymer,
wherein an inner circumferential surface of the tube has irregularities with arithmetic average roughness Ra of 1 μm or more.

To solve the problem described above, the invention also provides a method for manufacturing a resin tube, comprising:
manufacturing a molding material comprising a fluoropolymer composition by kneading a first fluoropolymer and a second fluoropolymer, the first fluoropolymer comprising a melt-type fluoropolymer that melts at a temperature higher than a melting point, and the second fluoropolymer comprising polytetrafluoroethylene or a cross-linked fluoropolymer; and
molding a tube having irregularities with arithmetic average roughness Ra of 1 μm or more on an inner circumferential surface by molding the molding material into a tube shape.

### ADVANTAGEOUS EFFECTS OF THE INVENTION

According to the invention, it is possible to provide a resin tube with improved sliding properties and abrasion resistance, and a method for manufacturing the resin tube.

### BRIEF DESCRIPTION OF DRAWINGS

FIGS. 1A and 1B show diagrams illustrating a resin tube in an embodiment of the present invention, wherein FIG. 1A is a perspective view thereof, and FIG. 1B is a perspective view when electric wires 2 are passed through a hollow portion 1a.

FIG. 2 shows photographs of an inner circumferential surface of the resin tube obtained using a scanning electron microscope.

FIG. 3 shows photographs of an outer circumferential surface of the resin tube obtained using a scanning electron microscope.

FIG. 4 is a flowchart showing a procedure of a method for manufacturing the resin tube in the embodiment of the invention.

### DETAILED DESCRIPTION OF THE INVENTION

### Embodiment

An embodiment of the invention will be described below in conjunction with the appended drawings.

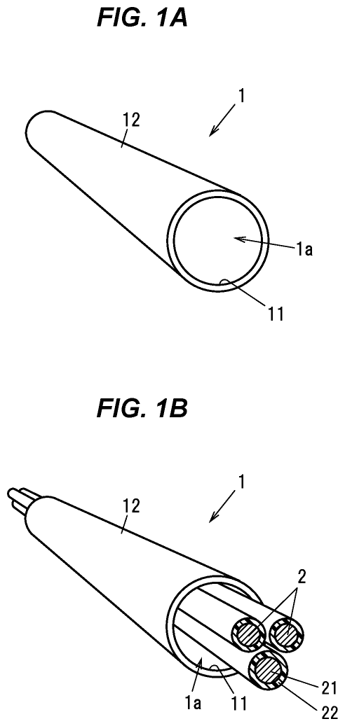

FIGS. 1A and 1B show diagrams illustrating a resin tube 1 in an embodiment of the invention, wherein FIG. 1A is a perspective view thereof, and FIG. 1B is a perspective view when electric wires 2 are passed through a hollow portion 1a.

As shown in FIG. 1A, the resin tube 1 is a cylindrical tube that has the hollow portion 1a along a longitudinal direction. The resin tube (=tube) 1 is configured in such a manner that shapes of an inner circumferential surface 11 and an outer circumferential surface 12 are substantially coaxially circles when viewed in a transverse cross-section (when viewed in a cross-section perpendicular to the longitudinal direction) and its thickness is substantially the same in a circumferential direction. In this regard, the shape of the resin tube 1 is not limited to the cylindrical shape as long as at least it has the hollow portion 1a along the longitudinal direction.

As shown in FIG. 1B, the resin tube 1 is used, e.g., to protect the electric wires 2 at a portion where the electric wires 2 are repeatedly bent and twisted (e.g., at a moving part of an industrial robot, etc.). In this case, not less than one electric wire 2 (three electric wires 2 in the illustrated example) is inserted through the hollow portion 1a of the resin tube 1. The electric wires 2 may be, e.g., used for internal wiring of an industrial robot. The electric wires 2 may alternatively be, e.g., used to connect an industrial robot to a control device. In addition, although the illustrated example shows a case where the electric wire 2 is an insulated wire in which an insulation 22 is provided around a conductor 21, it is not limited thereto. The electric wire 2 may be, e.g., a cable such as a coaxial wire having an outer conductor around the insulation 22, or a multicore cable with plural cores composed of the electric wires 2 or coaxial wires. The inner and outer diameters of the resin tube 1 can be appropriately changed according to the number of the electric wires 2 or cables to be inserted through the hollow portion 1a, or the intended use of the resin tube 1, etc. The thickness of the resin tube 1 can also be appropriately changed according to the number of the electric wires 2 or cables to be inserted through the hollow portion 1a, or the intended use of the resin tube 1, etc.

The application use of the resin tube 1 is not limited to the above-described protection of the electric wires 2. The resin tube 1 may be used as, e.g., a liquid delivery tube carrying a liquid through the hollow portion 1a. In this case, the resin tube 1 may be used, e.g., in medical applications where a liquid medicine or blood, etc., is passed through the hollow portion 1a.

The resin tube 1 is composed of a molded body (i.e., molded article) of a fluoropolymer composition having high sliding properties. The fluoropolymer composition used for the resin tube 1 in the present embodiment is a mixture of a first fluoropolymer, which is a melt-type fluoropolymer that melts at a temperature higher than a melting point, and a second fluoropolymer, which is a non-melt-type fluoropolymer. The fluoropolymer composition may be a mixture containing other resins or fibers than the first and second fluoropolymers that constitute its main components. As the other resins, e.g., polyamide-imide resin, silicone resin, and epoxy resin, or the like may be used. As the fibers, e.g., carbon fiber, glass fiber, metal fiber, silicon carbide fiber, silicon nitride fiber, aramid fiber, alumina fiber, polyamide fiber, polyethylene fiber, polyester fiber, and ceramic fiber, or the like may be used.

As the first fluoropolymer which is a melt-type fluoropolymer, e.g., a fluorinated resin copolymer such as perfluoroalkoxy alkane (PFA), perfluoroethylene propylene copolymer (FEP), and ethylene tetrafluoroethylene copolymer (ETFE) may be used. As the second fluoropolymer which is a non-melt-type fluoropolymer, polytetrafluoroethylene (PTFE) or a cross-linked fluoropolymer may be used. As the cross-linked fluoropolymer, e.g., a material obtained by cross-linking the melt-type fluoropolymer used as the first fluoropolymer or by cross-linking PTFE may be used. In more particular, cross-linked PTFE, cross-linked PFA, cross-linked FEP, or the like may be used. The cross-linked fluoropolymer can be obtained by, e.g., using a method in which the melt-type fluoropolymer or PTFE mentioned above, in a state of being heated to a temperature equal to or more than the melting point of the above fluoropolymer, is exposed to ionizing radiation such as electron beam at an irradiation dose of 1 kGy or more and 10 MGy or less in an atmosphere with an oxygen concentration of 500 ppm or less.

Although the details will be described later, when manufacturing the resin tube 1, the second fluoropolymer in the form of powder (in the form of fine particles) is dispersed in the first fluoropolymer. The second fluoropolymer, which is of the non-melt-type, does not melt even when heated to equal to or more than its melting point, and thus maintains its particulate state even during molding. As a result, when the second fluoropolymer is molded together with the melt-type first fluoropolymer, minute irregularities derived from the second fluoropolymer occur on the inner circumferential surface 11 of the resin tube 1 (actually, on the entire surface of the resin tube 1 including the inner circumferential surface 11 and the outer circumferential surface 12) due to the particulate second fluoropolymer. That is, on the inner and outer circumferential surfaces 11 and 12 of the resin tube 1, the particulate second fluoropolymer is present in a dispersed state and minute irregularities derived from said second fluoropolymer are formed. In this regard, since the non-melt-type second fluoropolymer does not melt, it is difficult to perform molding (extrusion molding, etc., which will be described later) of the resin tube 1 when using only the second fluoropolymer. For this reason, molding of the resin tube 1 is preferably performed using the material in which the second fluoropolymer is dispersed in the melt-type first fluoropolymer.

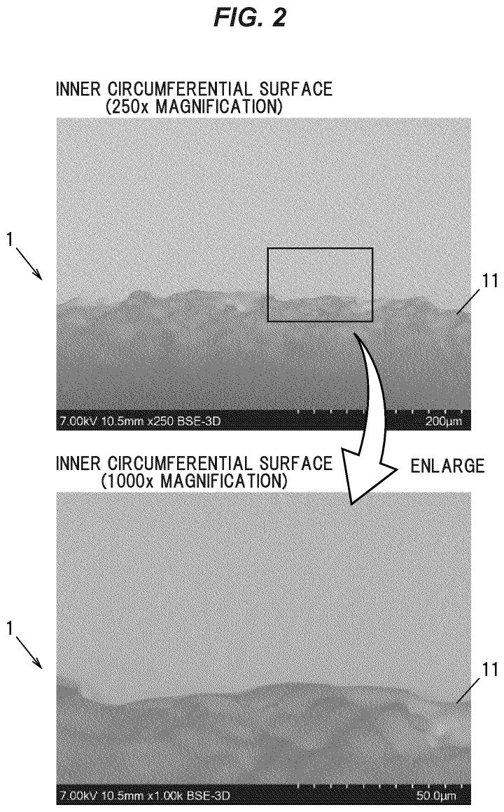

FIG. 2 shows photographs (SEM images) of the inner circumferential surface 11 of the resin tube 1 obtained using a scanning electron microscope (SEM). As shown in FIG. 2, minute irregularities on the order of several to tens of μm are formed on the inner circumferential surface 11 of the resin tube 1. Since the contact area with the electric wires 2 inserted through the hollow portion 1a is reduced by having such minute irregularities, friction between the inner circumferential surface 11 of the resin tube 1 and the electric wires 2 is reduced, which increases sliding properties and suppresses abrasion of the electric wires 2 due to contact with the inner circumferential surface 11 of the resin tube 1.

In addition, since the inner circumferential surface 11 has the above-described minute irregularities, liquid is less likely to adhere to the resin tube 1 due to the so-called lotus effect, which enables, e.g., smooth liquid delivery when used as a liquid delivery tube.

Furthermore, the first and second fluoropolymers are both fluoropolymers and are thus tightly integrated with substantially no interfaces after molding. That is, the resin tube 1 has a uniform surface that is continuous in the thickness direction (and the circumferential direction) when viewed in a transverse cross-section, and there are no boundaries that could be points from which peeling starts. Therefore, there is no concern of a portion of the inner circumferential surface 11 falling off due to contact with the electric wires 2, etc., inserted through the hollow portion 1a, and there is not a problem that, e.g., a coated portion peels off when coated with a layer for lubrication. Therefore, it is possible to achieve very high abrasion resistance and it is possible to achieve very high resistance properties even in harsh environments where, e.g., bending and twisting are applied simultaneously.

In more particular, the inner circumferential surface 11 of the resin tube 1 has irregularities with arithmetic average roughness Ra of 1 μm or more, more preferably 3 μm or more. In this regard, however, if the surface roughness is too large (when irregularities are extreme), the thickness of the resin tube 1 does not become stable and also pinholes penetrating the resin tube 1 in a radial direction are likely to occur, hence, the inner circumferential surface 11 of the resin tube 1 preferably has irregularities with arithmetic average roughness Ra of 20 μm or less, more preferably 10 μm or less. That is, the inner circumferential surface 11 of the resin tube 1 preferably has irregularities with arithmetic average roughness Ra of 1 μm or more and 20 μm or less, more preferably 3 μm or more and 10 μm or less.

In addition, a ten-point average roughness Rz of the inner circumferential surface 11 of the resin tube 1 is preferably 8 μm or more and 100 μm or less, more preferably 25 μm or more and 50 μm or less. The surface roughness (the arithmetic average roughness Ra and the ten-point average roughness Rz) described here is the value obtained by measurement according to JIS B 0601.

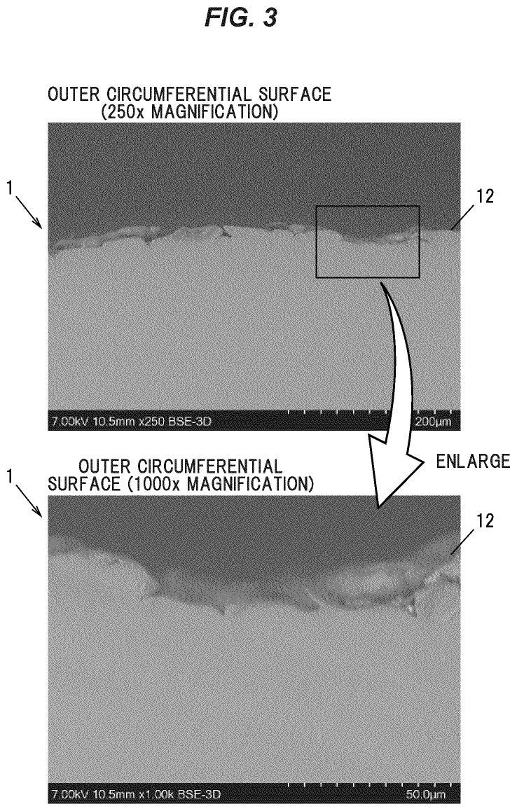

Irregularities are formed also on the outer circumferential surface 12 of the resin tube 1, in the same manner as the inner circumferential surface 11. FIG. 3 shows photographs (SEM images) of the outer circumferential surface 12 of the resin tube 1 obtained using a scanning electron microscope (SEM). The outer circumferential surface 12 of the resin tube 1 has irregularities with arithmetic average roughness Ra of 1 μm or more, more preferably 3 μm or more. The arithmetic average roughness Ra of the outer circumferential surface 12 is preferably 1 μm or more and 20 μm or less, more preferably 3 μm or more and 10 μm or less, in the same manner as the inner circumferential surface 11. In addition, a ten-point average roughness Rz of the outer circumferential surface 12 is preferably 8 μm or more and 100 μm or less, more preferably 25 μm or more and 50 μm or less.

In, e.g., industrial robots, liquid substances such as paint, water droplets or oil possibly adhere to the outer circumferential surface 12 of the resin tube 1. According to the present embodiment, the lotus effect due to the minute irregularities makes it difficult for liquid substances to adhere to the outer circumferential surface 12 of the resin tube 1, and the liquid substances even when adhered can be easily wiped off. In addition, since the first and second fluoropolymers of the resin tube 1 are tightly integrated with substantially no interfaces, there is no concern of, e.g., the surface being peeled off by wiping off an adhered liquid substance, etc., and sliding properties and abrasion resistance degrade very little. In, e.g., medical applications, disinfection with alcohol and wiping of the resin tube 1 is possibly repeated, but even when such wiping is repeated, the resin tube 1 shows very little degradation in sliding properties and abrasion resistance.

Now, a ratio of the first fluoropolymer to the second fluoropolymer is examined. The fluoropolymer composition constituting the resin tube 1 preferably includes 30 mass % or more and 99 mass % or less of the first fluoropolymer and 1 mass % or more and 70 mass % or less of the second fluoropolymer. In other words, a mass ratio of the first fluoropolymer to the second fluoropolymer (the first fluoropolymer/the second fluoropolymer) is preferably 30/70 or more and 99/1 or less. As a result, it is easy to disperse the non-melt-type second fluoropolymer in the melt-type first fluoropolymer and it is easy to perform extrusion molding of the tubular resin tube 1 which has minute irregularities at least on the inner circumferential surface 11.

More preferably, the fluoropolymer composition constituting the resin tube 1 includes 50 mass % or more and 95 mass % or less of the first fluoropolymer and 5 mass % or more and 50 mass % or less of the second fluoropolymer. In other words, the mass ratio of the first fluoropolymer to the second fluoropolymer (the first fluoropolymer/the second fluoropolymer) is preferably 50/50 or more and 95/5 or less. When the second fluoropolymer is 5 mass % or more, the effect of using the second fluoropolymer, such as improvement in sliding properties and abrasion resistance (i.e., capable of achieving higher sliding properties and abrasion resistance), is more likely to be exerted. When the second fluoropolymer is 50 mass % or less, the strength of the resin tube 1 is less likely to decrease and it is thereby possible to ensure strength against bending and tension.

Further preferably, the fluoropolymer composition constituting the resin tube 1 includes 60 mass % or more and 90 mass % or less of the first fluoropolymer, and 10 mass % or more and 40 mass % or less of the second fluoropolymer. In other words, the mass ratio of the first fluoropolymer to the second fluoropolymer (the first fluoropolymer/the second fluoropolymer) is preferably 60/40 or more and 90/10 or less. When the second fluoropolymer is 10 mass % or more, the above-described minute irregularities are more easily formed on the inner circumferential surface 11 and the outer circumferential surface 12, and the effect of using the second fluoropolymer, such as improvement in sliding properties and abrasion resistance, is more likely to be exerted. When the second fluoropolymer is 40 mass % or less, the strength of the resin tube 1 is less likely to decrease and it is thereby possible to ensure strength against bending and tension.

### Method for Manufacturing the Resin Tube 1

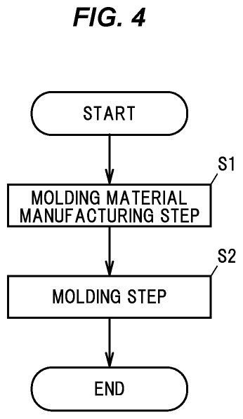

FIG. 4 is a flowchart showing a procedure of a method for manufacturing the resin tube 1 in the present embodiment. As shown in FIG. 4, in the manufacturing of the resin tube 1, a molding material manufacturing step (Step S1) and a molding step (Step S2) are performed sequentially.

In the molding material manufacturing step of Step S1, the first fluoropolymer made of a melt-type fluoropolymer and the second fluoropolymer made of a non-melt-type fluoropolymer are placed in a kneader such as a twin-screw kneader, and after kneading these fluoropolymers while heating, the kneaded fluoropolymer composition is extruded from the kneader and the extruded fluoropolymer composition is molded using a pelletizer, etc., thereby obtaining a molding material (i.e., a material to manufacture the molded body) composed of pellets or sheets of the fluoropolymer composition. In this regard, from the viewpoint of ease of molding the resin tube 1 having the above-mentioned minute irregularities, the molding material is preferably composed of pellets. The fluoropolymer composition obtained by kneading in the kneader may be cooled immediately after being extruded from the kneader or immediately after being molded into pellets, etc.

In the molding material manufacturing step, the second fluoropolymer in the form of powder is used as a raw material. The particle diameter of the second fluoropolymer used here affects the degree of irregularities of the inner and outer circumferential surfaces 11 and 12 (i.e., the arithmetic average roughness Ra of the inner and outer circumferential surfaces 11 and 12) after the resin tube 1 is molded. Therefore, in the molding material manufacturing step, it is desirable to use the second fluoropolymer in the form of powder with an average particle diameter of 0.1 μm or more and 100 μm or less so that an appropriate degree of irregularities (irregularities on the order of several to tens of μm) can be achieved after the resin tube 1 is molded. By setting the average particle diameter of the second fluoropolymer to 0.1 μm or more, it is possible to suppress the problem that the irregularities are too small to obtain the effect. In addition, by setting the average particle diameter of the second fluoropolymer to 100 μm or less, it is possible to suppress the occurrence of cracks at interfaces between the first and second fluoropolymers and also possible to suppress variations in wall thickness and occurrence of pinholes due to extreme irregularities, and it is thereby possible to realize the resin tube 1 having a stable thickness and no pinholes. In this regard, the average particle diameter is obtained using a laser diffraction particle size distribution analyzer (e.g., Microtrac-FRA manufactured by Microtrac).

A resin temperature during kneading in the molding material manufacturing step is desirably the melting point or more of the first fluoropolymer used and the melting point+70° C. or less of the first fluoropolymer (more preferably, the melting point+10° C. or more of the first fluoropolymer and the melting point+50° C. or less of the first fluoropolymer). By setting the resin temperature to the melting point+10° C. or more of the first fluoropolymer, it is easy to ensure the flowability of the melt-type first fluoropolymer and uniformly disperse the second fluoropolymer. By setting the resin temperature to the melting point+70° C. or less of the first fluoropolymer, it is possible to suppress difficulty in manufacturing the molding material such as pellets due to decomposition of the melt-type first fluoropolymer or difficulty in molding the resin tube 1 using the molding material. Furthermore, by setting the resin temperature to the melting point+50° C. or less of the first fluoropolymer, decomposition of the first fluoropolymer is suppressed more easily, which further facilitates manufacturing of the molding material such as pellets or facilitates molding of the resin tube 1.

In the molding step of Step S2, the molding material composed of pellets, etc.

manufactured in the molding material manufacturing step is placed in an extruder and extruded into a tubular shape at a predetermined resin temperature (described later). A tube having irregularities with arithmetic average roughness Ra of 1 μm or more on the inner circumferential surface 11 (i.e., the resin tube 1) is thereby obtained. A resin temperature during extrusion molding in the molding step is also desirably the melting point or more of the first fluoropolymer used and the melting point+70° C. or less of the first fluoropolymer (more preferably, the melting point+10° C. or more of the first fluoropolymer and the melting point+50° C. or less of the first fluoropolymer), in the same manner as the resin temperature during kneading in the molding material manufacturing step. In this regard, in the molding step, a molding method other than extrusion molding (e.g., injection molding, etc.) may be used to mold the tubular resin tube 1 having the hollow portion 1a along the longitudinal direction. In the molding step, it is preferable to mold the resin tube 1 by extrusion molding from the viewpoint of ease of molding the resin tube 1 having the above-mentioned minute irregularities.

Trial production and Evaluation of Trial product

Samples were prepared from the resin tube 1 shown in FIG. 1A produced as a trial, and the surface roughness measurement was conducted on the samples. In Examples 1 and 2, PFA was used as the first fluoropolymer and cross-linked PTFE with an average particle diameter of about 20 μm was used as the second fluoropolymer. The mass ratio of the first fluoropolymer to the second fluoropolymer was 70/30. In the molding material manufacturing step, a molding material composed of pellets was made using a twin-screw kneader at a resin temperature of 350° C. Then, in the molding step, the resin tubes 1 were formed by extrusion molding at a resin temperature of 330° C. or more and 350° C. or less. The inner diameter of the resin tube 1 was about 4.3 mm, and the outer diameter was about 5.3 mm. Surface roughness was measured according to JIS B 0601, by using a small surface roughness measuring instrument SJ-210 manufactured by Mitutoyo Corporation. A resin tube as Comparative Example, which has the same configuration as that of Examples 1 and 2 except that the second fluoropolymer is not used, was also made and the surface roughness was measured in the same manner. The results are summarized in Table 1.

TABLE 1

| | | Surface roughness | |
|---|---|---|---|
| | | Ra (μm) | Rz (μm) |
| Example 1 | Outer circumferential surface | 9.9 | 49.1 |
| | Inner circumferential surface | 3.1 | 29.1 |
| Example 2 | Outer circumferential surface | 6 | 39.6 |
| | Inner circumferential surface | 8.3 | 46.1 |
| Comparative | Outer circumferential surface | 0.1 | 0.8 |
| Example | Inner circumferential surface | 0.5 | 3.6 |

As shown in Table 1, in Examples 1 and 2, both the inner circumferential surface 11 and the outer circumferential surface 12 had arithmetic average roughness Ra of 1 μm or more (more specifically, 3.1 μm or more), which confirmed that minute irregularities were formed. In addition, in Examples 1 and 2, the ten-point average roughness Rz was 29.1 μm or more and 49.1 μm or less. On the other hand, in Comparative Example, the inner circumferential surface and the outer circumferential surface had arithmetic average roughness Ra of less than 1 μm (more specifically, 0.5 μm or less), which confirmed that minute irregularities were not formed and the surface was smooth.

### Functions and Effects of the Embodiment

As described above, the resin tube 1 in the present embodiment is composed of the fluoropolymer composition obtained by mixing the first fluoropolymer made of a melt-type fluoropolymer which melts at a temperature higher than a melting point, with the second fluoropolymer, which is a non-melt-type fluoropolymer made of polytetrafluoroethylene or a cross-linked fluoropolymer, and the inner circumferential surface 11 has irregularities with arithmetic average roughness Ra of 1 μm or more.

As a result, the sliding properties of the inner circumferential surface 11 is increased, and abrasion of the electric wires 2, etc., inserted through the hollow portion 1a can be suppressed. In addition, the first fluoropolymer and the second fluoropolymer are both fluoropolymers and thus are firmly integrated, hence, there is no problem of surface peeling from the inner circumferential surface 11 or the outer circumferential surface 12 of the resin tube 1 and abrasion resistance can be increased. Furthermore, liquids are less likely to adhere due to the lotus effect caused by minute irregularities, and liquids even when adhered can be easily wiped off.

### Summary of the Embodiment

Technical ideas understood from the embodiment will be described below citing the reference signs, etc., used for the embodiment. However, each reference sign, etc., described below is not intended to limit the constituent elements in the claims to the members, etc., specifically described in the embodiment.

According to the first feature, a resin tube 1 is a tube that is composed of a first fluoropolymer and a second fluoropolymer, the first fluoropolymer being made of a melt-type fluoropolymer that melts at a temperature higher than a melting point, and the second fluoropolymer being made of polytetrafluoroethylene or a cross-linked fluoropolymer, wherein an inner circumferential surface 11 of the tube has irregularities with arithmetic average roughness Ra of 11 μm or more.

According to the second feature, in the resin tube 1 as described by the first feature, the inner circumferential surface 11 has the irregularities with the arithmetic average roughness Ra of 3 μm or more and 10 μm or less.

According to the third feature, in the resin tube 1 as described by the first feature, an outer circumferential surface 12 of the tube has irregularities with arithmetic average roughness Ra of 11 μm or more.

According to the fourth feature, in the resin tube 1 as described by the first feature, the tube includes 30 mass % or more and 99 mass % or less of the first fluoropolymer and 1 mass % or more and 70 mass % or less of the second fluoropolymer.

According to the fifth feature, in the resin tube 1 as described by the first feature, the tube includes 50 mass % or more and 95 mass % or less of the first fluoropolymer and 5 mass % or more and 50 mass % or less of the second fluoropolymer.

According to the sixth feature, in the resin tube 1 as described by the first feature, the tube includes 60 mass % or more and 90 mass % or less of the first fluoropolymer, and 10 mass % or more and 40 mass % or less of the second fluoropolymer.

According to the seventh feature, a method for manufacturing a resin tube includes manufacturing a molding material made of a fluoropolymer composition by kneading a first fluoropolymer and a second fluoropolymer, the first fluoropolymer being made of a melt-type fluoropolymer that melts at a temperature higher than a melting point, and the second fluoropolymer being made of polytetrafluoroethylene or a cross-linked fluoropolymer; and molding a tube having irregularities with arithmetic average roughness Ra of 1 μm or more on an inner circumferential surface 11 by molding the molding material into a tube shape.

According to the eighth feature, in the method for manufacturing a resin tube as described by the seventh feature, the second fluoropolymer in the form of powder with an average particle diameter of 0.1 μm or more and 100 μm or less is used in the manufacturing of the molding material.

According to the ninth feature, in the method for manufacturing a resin tube as described by the seventh feature, a resin temperature during kneading in the manufacturing of the molding material and a resin temperature during molding in the molding are the melting point or more of the first fluoropolymer and the melting point+70° C. or less of the first fluoropolymer.

Although the embodiment of the invention has been described, the invention according to claims is not to be limited to the embodiment described above. Further, please note that not all combinations of the features described in the embodiment are necessary to solve the problem of the invention.

In addition, the invention can be appropriately modified and implemented without departing from the gist thereof. For example, the resin tube 1 having one hollow portion 1a along the longitudinal direction has been described in the embodiment, it is not limited thereto. The resin tube 1 may have plural hollow portions 1a along the longitudinal direction. In this case, the resin tube 1 can be used in applications where a liquid is passed through some of the plural hollow portions 1a and the electric wires 2 are passed through the other hollow portions 1al .

1. A resin tube, comprising:
a tube that comprises a first fluoropolymer and a second fluoropolymer, the first fluoropolymer comprising a melt-type fluoropolymer that melts at a temperature higher than a melting point, and the second fluoropolymer comprising polytetrafluoroethylene or a cross-linked fluoropolymer,
wherein an inner circumferential surface of the tube has irregularities with arithmetic average roughness Ra of 1 μm or more.

2. The resin tube according to claim 1, wherein the inner circumferential surface has the irregularities with the arithmetic average roughness Ra of 3 μm or more and 10 μm or less.

3. The resin tube according to claim 1, wherein an outer circumferential surface of the tube has irregularities with arithmetic average roughness Ra of 1 μm or more.

4. The resin tube according to claim 1, wherein the tube comprises 30 mass % or more and 99 mass % or less of the first fluoropolymer, and 1 mass % or more and 70 mass % or less of the second fluoropolymer.

5. The resin tube according to claim 1, wherein the tube comprises 50 mass % or more and 95 mass % or less of the first fluoropolymer, and 5 mass % or more and 50 mass % or less of the second fluoropolymer.

6. The resin tube according to claim 1, wherein the tube comprises 60 mass % or more and 90 mass % or less of the first fluoropolymer, and 10 mass % or more and 40 mass % or less of the second fluoropolymer.

7. A method for manufacturing a resin tube, comprising:
manufacturing a molding material comprising a fluoropolymer composition by kneading a first fluoropolymer and a second fluoropolymer, the first fluoropolymer comprising a melt-type fluoropolymer that melts at a temperature higher than a melting point, and the second fluoropolymer comprising polytetrafluoroethylene or a cross-linked fluoropolymer; and
molding a tube having irregularities with arithmetic average roughness Ra of 1 μm or more on an inner circumferential surface by molding the molding material into a tube shape.

8. The method according to claim 7, wherein the second fluoropolymer in the form of powder with an average particle diameter of 0.1 μm or more and 100 μm or less is used in the manufacturing of the molding material.

9. The method according to claim 7, wherein a resin temperature during kneading in the manufacturing of the molding material and a resin temperature during molding in the molding are the melting point or more of the first fluoropolymer and the melting point+70° C. or less of the first fluoropolymer.
